(19) United States
(12) Patent Application Publication
(10) Pub. No.: US 2007/0214969 A1
(43) Pub. Date: Sep. 20, 2007

(54) Method and Device for Slicing Food Bars

(76) Inventors: Peter Mueller, Kempten (DE); Alois Bochtler, Egg (DE); Wilfried Maier, Dietmannsried (DE)

Correspondence Address: PERMAN & GREEN, 425 POST ROAD, FAIRFIELD, CT, 06824, US

(21) Appl. No.: 10/576,233

(22) PCT Filed: Oct. 15, 2004
(86) PCT No.: PCT/EP04/11668

§ 371 Date: Jan. 12, 2007

(30) Foreign Application Priority Data
Oct. 15, 2003 (DE) 103 48 657.7
Nov. 12, 2003 (DE) 103 53 114.9

(51) Int. Cl. A23L 1/025

(52) U.S. Cl. 99/485; 426/518

(57) ABSTRACT

The present invention relates to methods for simultaneously slicing at least two food product blocks fed to a blade. The present invention additionally relates to a device for severing food product slices and a means for extending product bars, in particular food product blocks, artificially in the axial direction and to a corresponding slicing device.

The present invention relates to methods for simultaneously slicing at least two food product blocks fed to a blade. The present invention additionally relates to a device for severing food product slices and a means for extending product bars, in particular food product blocks, artificially in the axial direction and to a corresponding slicing device.

Bar-shaped food products, for example sausage, cheese or the like are cut into slices with very high cutting productivity using high-performance slicing machines, so-called slicers. The food product bar is conveyed by means of a controlled drive through a stationary cutting plane, in which cutting is performed by a rapidly moving blade. The slice thickness results from the distance the food product block is advanced between two cuts. Accordingly, at a constant blade speed slice thickness is controlled by means of the rate of feed of the food product block. The cut slices are as a rule combined into portions comprising a consistent number of slices and packaged. The weight of such a portion needs to be observed as precisely as possible. The weight may be adjusted by influencing the slice thickness by means of the rate of feed. For reasons of productivity, current slicers often slice a plurality of product bars next to one another using one blade. The prior art discloses both continuously and discontinuously charged machines.

In continuously charged slicing machines, the means for advancing of the food product block generally consists of several, preferably two, conveyor belts, between which the food product bars are clamped and conveyed through the cutting plane by means of static friction. The conveyor belts are open on the inlet side, such that the end face of the next product can come into contact with the end of the product being sliced, resulting in an approximately continuous cutting process. A disadvantage of this system is that towards the end of the product slicing process the remainder of the food product block can no longer be clamped firmly enough between the conveyor belts, such that it is often torn out by the blade and flung away.

With discontinuously charged slicing machines, the product bar, also known as a food product block, is gripped at its end remote from, the blade by a gripper and conveyed thereby in the direction of the blade. These slicing machines have the disadvantage, for example, that very long food product blocks cannot be processed on these machines and that, when slicing a plurality of parallel food product blocks using mechanically firmly connected grippers, the food product blocks are sometimes severely compressed prior to slicing.

It was therefore an object of the present invention to provide methods which do not exhibit the disadvantages of the prior art.

The object is achieved with a method according to claim 1.

For the purposes of the invention, the means which are brought into contact with the ends of the food product blocks remote from the blade may be any desired means known to the person skilled in the art. The means may for example preferably be grippers, whose claws are pressed into the food product blocks or which bring about some other, preferably reversible, interlocking and/or force-locking connection with the food product block. However, for the purposes of the invention, a means is also a product extender, as described below.

It was extremely surprising to the person skilled in the art and not at all expected that it should be possible, with the method according to the invention, to slice food product blocks of any length. The method according to the invention may be carried out using comparatively small slicing machines, because the means, for example a gripper, has to be brought into contact with the food product block only at a comparatively late stage.

The present invention further provides a method for simultaneously slicing at least two food product blocks fed in parallel to a blade, in which the food product blocks are each inserted into a feed passage and optionally brought into contact with a limit stop and conveyed towards the blade and sliced, and the ends of the food product blocks remote from the blade are each brought into contact with a means such that the food product blocks are not compressed or are compressed only insignificantly by the means.

For the purposes of the invention, the means which are brought into contact with the ends of the food product blocks remote from the blade may be any desired means known to the person skilled in the art. The means may for example preferably be grippers, whose claws are pressed into the food product blocks or which bring about some other, preferably reversible, interlocking and/or force-locking connection with the food product block. However, for the purposes of the invention, a means is also a product extender, as described below.

It was extremely surprising to the person skilled in the art and not at all expected that it should be possible, with the method according to the invention, to slice food product blocks in parallel with one another without the need to perform a trimming cut. The method according to the invention is simple and cheap to carry out.

The present invention further relates to a method of slicing a food product block fed to a blade, wherein the food product block is conveyed towards the blade by at least one conveying means and in which, at any desired time before or during slicing of the food product block, the rear end of the food product block is brought into contact with a means and the means is driven during said contact with the food product block by the food product block and/or the conveying means.

The means which is brought into contact with the ends of the food product blocks remote from the blade may be any desired means known to the person skilled in the art. The means may for example preferably be a gripper, whose claws are pressed into the food product blocks or which bring about some other, preferably reversible, interlocking and/or force-locking connection with the food product block. However, for the purposes of the invention, a means is also a product extender, as described below.

Preferably a plurality of food product blocks are sliced in parallel.

It was extremely surprising to the person skilled in the art and not at all expected that it should be simply possible, with the method according to the invention, to slice up food product blocks of any length almost completely. Food product blocks of any desired length may be sliced. The method according to the invention is simple and cheap to carry out.

The present invention further provides a method for simultaneously slicing at least two food product blocks fed in parallel to a blade, in which the food product blocks are each inserted into a feed passage and optionally brought into contact with a limit stop, conveyed towards the blade and sliced, and the ends of the food product blocks remote from the blade are each brought into contact with a means, wherein the front ends of the food product blocks are arranged in such a way that they are located prior to the first cut in a plane substantially parallel to the cutting plane of the blade, such that no trimming cut has to be performed.

The means which are brought into contact with the ends of the food product blocks remote from the blade may be any desired means know to the person skilled in the art. The means may for example preferably be grippers, whose claws are pressed into the food product blocks or which bring about some other, preferably reversible, interlocking and/or force-locking connection with the food product block. However, for the purposes of the invention, a means is also a product extender, as described below.

It was extremely surprising to the person skilled in the art and not at all expected that it should be possible, with the present method, to slice a plurality of food product blocks in parallel without the need to perform trimming cuts. The method according to the invention is simple and cheap to carry out.

The present invention further provides a method of slicing food product blocks, in which a food product block is extended artificially before and/or during slicing by a food product block-extending means.

The means which are brought into contact with the ends of the food product blocks remote from the blade may be any desired means known to the person skilled in the art. The means may for example preferably be grippers, whose claws are pressed into the food product blocks or which bring about some other, preferably reversible, interlocking and/or force-locking connection with the food product block. However, for the purposes of the invention, a means is also a product extender, as described below.

It was extremely surprising to the person skilled in the art and not at all expected that it should be possible, with the method according to the invention, to slice up a food product block almost completely. The means may be brought into contact with the food product block during slicing, such that attaching the product extender to the food product block does not cause any time to be lost and the productivity of a slicing machine which implements the method according to the invention is thereby increased. The method according to the invention is simple and cheap to carry out.

The preferred embodiments described below relate to all the above-mentioned methods according to the invention.

Preferably, the means is for example a gripper with which food product blocks may be connected reversibly and force-lockingly, interlockingly and/or by material bonding.

It is also preferable for the connection between the means to be effected before or particularly preferably after slicing starts. Connection of the means, for example of a gripper, after slicing starts has the advantage that food product blocks of any desired length may be sliced. Connection between the means and the food product block is effected for example shortly before the rear end of the food product block is located in the area of the conveying means or shortly before so much of the food product block has been sliced that it can no longer definitely be held securely between the conveyor belts.

In another preferred embodiment, the means is removed from the feed passage after slicing. This preferably proceeds by drawing the means back out of the feed passage. In another preferred embodiment, the means is removed from the feed passage in such a way that the least possible time is lost. This preferably proceeds by movement of the means transversely of the feed passage.

In a further preferred embodiment of the present invention, the connection between the means and the food product blocks is broken once slicing of at least one food product block is completed. This means that it maybe advantageous for slicing of the other food product blocks, which have not as yet been almost completely sliced up, likewise to be terminated, the remaining end pieces being re-used. This procedure results in comparatively high average slicing productivity. In another preferred embodiment of the present invention, each food product block is sliced up to the maximum degree and resultant incomplete portions are made up with food product blocks to be sliced subsequently. This procedure results in maximum material utilisation. The operator may choose between these two modes of operation at any time and adapt them for example to the product to be sliced in each case.

In a further preferred embodiment of the method according to the invention, the means is driven, i.e. is moved in the direction of the blade, at least sometimes solely by the conveying means, preferably conveyor belts, which convey the food product blocks towards the blade and/or by the food product block itself. This means that the means, for example a gripper, sometimes is not driven by its own drive. Movement of the gripper in the direction of the blade accordingly proceeds for example in that it is connected force-lockingly with the food product block. Furthermore, conveying may proceed in that a force-locking connection, for example a frictional connection, is established between the means and the conveyor belts, which also convey the food product block, and the means is conveyed thereby in the direction of the blade. This embodiment of the method according to the invention has the advantage that the means have only to be driven and the drives only to be controlled to produce contact between the means and the food product block and optionally subsequently to remove the means from the feed passage. In the period in between, at least, the means is not driven independently.

The present invention further provides a device for severing food product slices from at least one food product block with a blade, in which device the food product block may be conveyed towards the blade by at least one conveying means and its rear end is in contact at least for a time with a means, wherein the means is not driven by its own drive at least during contact with the food product block.

The means which are brought into contact with the ends of the food product blocks remote from the blade may be any desired means known to the person skilled in the art. The means may for example preferably be grippers, whose claws are pressed into the food product blocks or which bring about some other, preferably reversible, interlocking and/or force-locking connection with the food product block. However, for the purposes of the invention, a means is also a product extender, as described below.

It was extremely surprising and unexpected for the person skilled in the art that the device according to the invention is simple and cheap to produce. Furthermore, the device according,to the invention is simple and cheap to operate, because the means have only to be driven independently sometimes or not at all.

In a preferred embodiment of the present invention, at least two food product blocks are each conveyed by at least one conveying means towards the blade and their rear end is brought into contact at least for a time in each case with a means, wherein the means are arranged on a central unit which is arranged on the device so as to be displaceable at least sometimes in parallel with the axis of rotation of the blade.

In another preferred embodiment of the present invention, at least two food product blocks are each conveyed by at least one conveying means towards the blade and their rear end is brought into contact at least for a time in each case with a means, wherein the means are mounted on a central unit so as in each case to be displaceable at least at times.

Preferably, a sensor is in each case arranged on the means, with which the position of the latter relative to the central unit may be determined.

The present invention further provides means for extending food product blocks in the axial direction, having a surface which cooperates force-lockingly and/or interlockingly with conveying means, which convey the food product blocks within a slicing device in the direction of the cutting plane, and a means arranged at the end face which effects a force-locking, interlocking and/or materially bonded connection between the means and the food product block.

It was extremely surprising and unexpected for the person skilled in the art that it should prove possible with the product-extending means to slice a food product block in controlled manner almost as far as the end, so as to minimise product waste. The means according to the invention is simple and cheap to produce and simple to insert into a slicing machine.

Preferably, the surface is the outer circumferential surface of a body, for example of a cylinder. The cross-section of the outer circumferential surface of the product-extending means may either correspond to the cross-section of the food product block to be sliced, or not. For example, it may be advantageous for the cross-section of the outer circumferential surface of the product-extending means to be rectangular, in order to enlarge the bearing surface between the means and the conveyor belts, with which the food product block and the product-extending means are conveyed.

In another preferred embodiment, the cross-section of the outer circumferential surface of the product-extending means is flexible, such that one product-extending means may be used for food product blocks of the widest possible range of cross-sections.

Preferably, the product-extending means is no longer driven by its own drive at least in the conveying direction of the food product and after the force-locking, interlocking and/or materially bonded connection, but rather it is driven by the conveying means which also convey the food product block in the direction of the cutting blade.

The force-locking, interlocking and/or materially bonded connection between the food product block and the product extender may be effected in any manner familiar to the person skilled in the art. Preferably, however, the means is a claw or grip system which is already in use for conveying food product blocks in slicing machines, wherein the claw or grip system may be so designed that a force-locking and/or interlocking connection is maintained even when the claw or grip system is no longer connected to a power source.

In another preferred embodiment, the connection between the product-extending means and the food product block is brought about by vacuum suction, which is applied once and is then maintained until slicing is completed, preferably even when the means is no longer connected to a suction device.

Preferably, the product-extending means comprises a means on the end face remote from the food product block by means of which the product-extending means may be brought up to the food product block to be extended.

The present invention further provides a slicing device with a blade which severs food product slices from a food product block which is conveyed by conveying means in a feed passage in the direction of the blade, wherein the slicing device comprises a means which removes a food product extender from the product passage.

The slicing device according to the invention has the advantage that, even in the case of continuous conveyance of the food product block, the product can be sliced in controlled manner almost as far as its end. It is additionally advantageous that the product extender at least for the most part does not require its own drive.

Preferably, the slicing device comprises a means which picks up the food product extender after removal thereof and brings it up to the end of a further product block to be extended.

Preferably, the slicing machine comprises a means with which a force-locking, interlocking and/or materially bonded connection may be produced between the food product block and the product extender. For example, this means may be an electrical connection or compressed air, with which a claw or grip system may be operated. Furthermore, this means may be a vacuum connection or a station in which an adhesive is applied to the product extender and/or the food product block, by means of which a material bond may be produced between the two components.

In a preferred embodiment of the present invention, the product extender is driven, at least in the conveying direction of the food product block and after the force-locking, interlocking and/or materially bonded connection has been produced, by the conveying means which also conveys the product block towards the cutting blade.

The present invention further provides a method of slicing product blocks, in which the product block is extended artificially before and/or during slicing by a product block-extending means.

The present method has the advantage that the product block may be sliced up almost completely even in the case of continuous conveyance. The method is simple and cheap to carry out.

Preferably, the product block-extending means may be connected reversibly and force-lockingly, interlockingly and/or by material bonding.

In a further preferred embodiment of the method according to the invention, connection of the product block-extending means and the product block to be extended takes place before or preferably after slicing starts.

It is also preferable for the food product block-extending means to be removed after slicing of the product block from the feed passage in which the food product block is conveyed in the direction of the cutting blade.

Preferably, the connection between the food product block-extending means and the food product block is broken again after completion of slicing, preferably after both components have been removed from the feed passage. The product-extending means may then be conveyed back, cleaned and/or disinfected and connected with a new food product block to be sliced.

It is additionally preferred for the product block-extending means to be driven, at least at times, solely by the conveying means which also convey the food product block in the direction of the cutting blade.

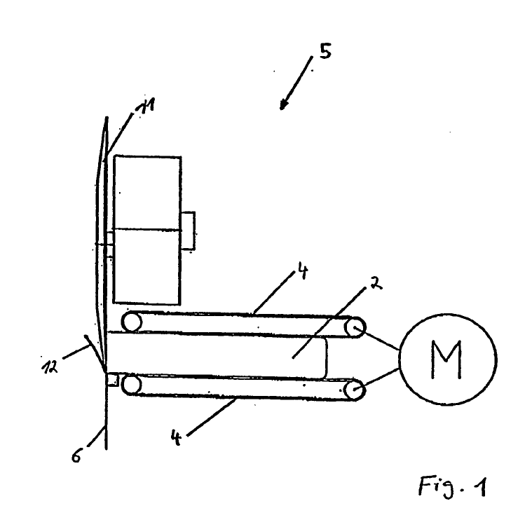

The invention is explained below with reference to FIGS. 1-6. These explanations are given merely by way of example and do not restrict the general concept of the invention. The explanations provided apply both to the method according to the invention and to the devices according to the invention, the extending means and the slicing devices.

FIG. 1 shows a slicing machine with virtually continuous product conveyance.

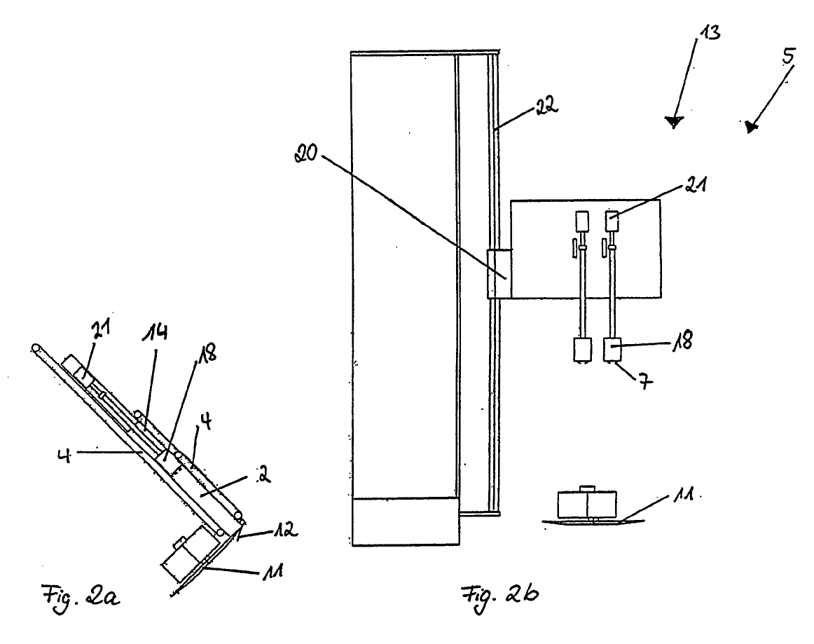

FIGS. 2a, 2b show two views of a slicing device according to the invention.

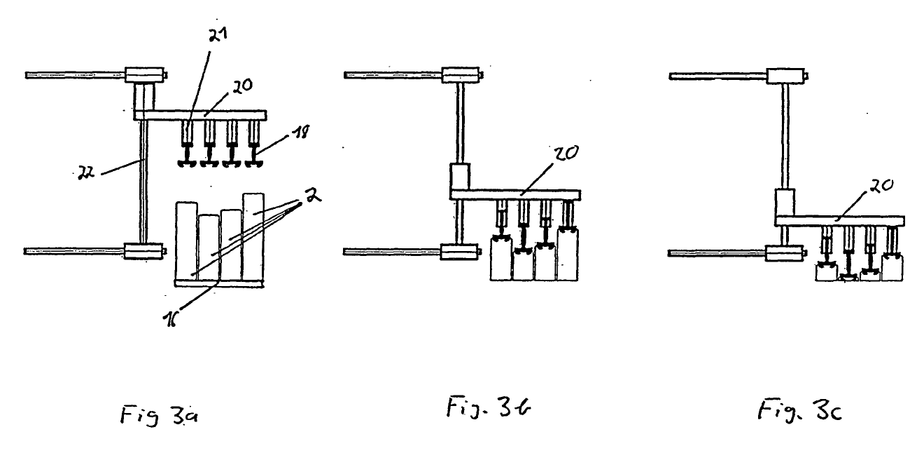

FIGS. 3a-3c show the slicing of four food product blocks in three phases.

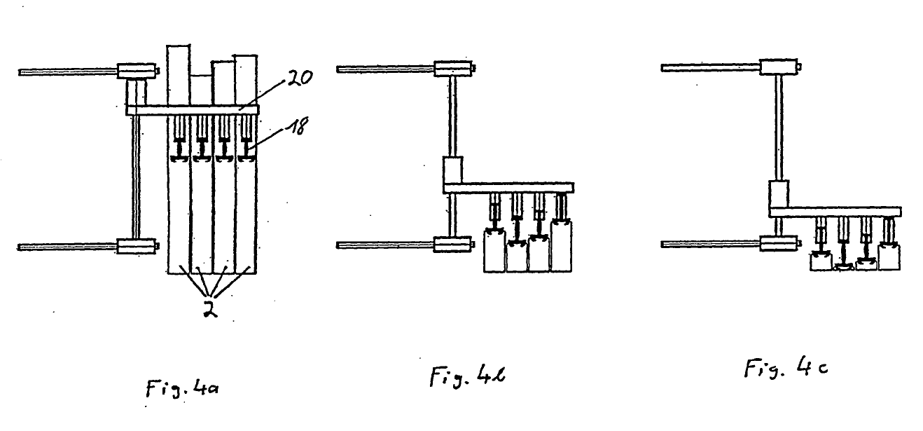

FIGS. 4a-4c show the slicing of four food product blocks in three phases.

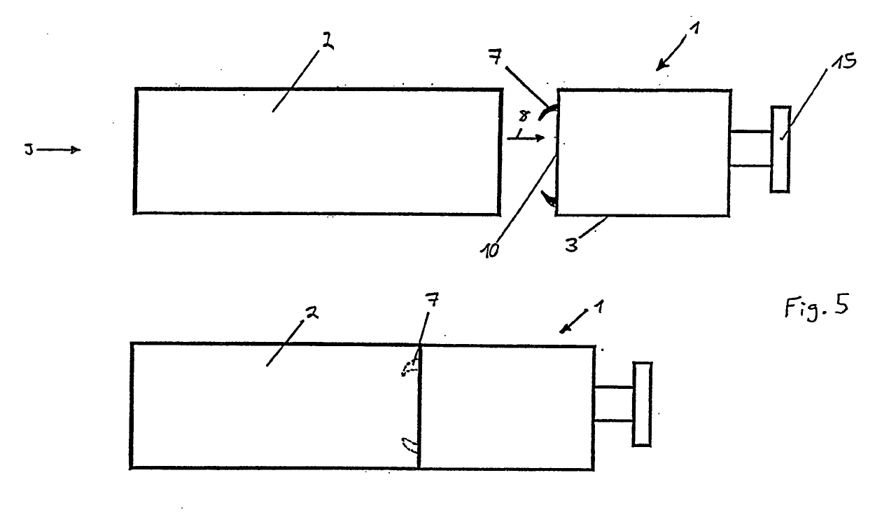

FIG. 5 shows the food product block extender and the associated food product block.

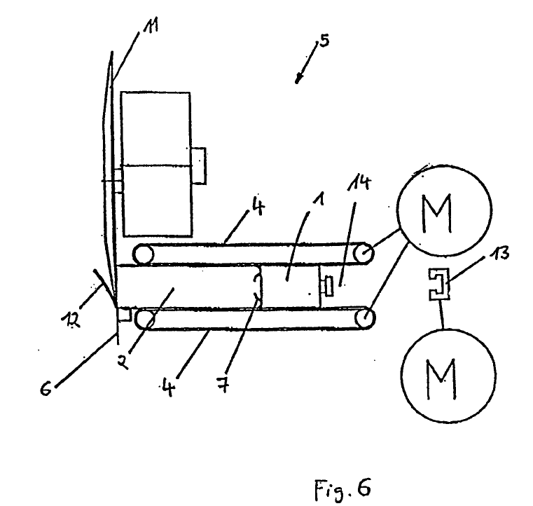

FIG. 6 shows the food product block extender in the slicing machine.

FIG. 1 shows a slicing machine which is charged virtually continuously. The slicing machine 5 comprises a blade 11, which cuts a food product block 2 into food product slices 12. As a rule, the sliced off food product slices 12 are assembled into portions and then packaged. The person skilled in the art will recognize that a plurality of food product blocks may be sliced simultaneously. The food product blocks 2 are conveyed continuously by means of two conveyor belts 4 in the direction of the cutting plane 6 of the blade 11. The slice thickness results from the distance the food product block is advanced between two cuts. At a constant blade speed, slice thickness is controlled by means of the rate of feed of the food product block. The conveyor belts 4 are open on the inlet side, such that the end face of the next product can come into contact with the end of the product being sliced, resulting in an approximately continuous cutting process.

FIGS. 2a and 2b show two views of a slicing machine according to the invention. FIG. 2a shows the blade head, at which is located the blade 11, with which food product blocks 2 are sliced into food product slices 12. The food product block 2 is conveyed by the conveyor belts 4 along the feed passage 14 in the direction of the blade. At its rear end, the food product block has been brought into contact with a gripper 18, whose own drive 20, 21 is illustrated in detail in FIG. 2b. A frictional connection exists between the gripper 18 and the conveyor belts 4, such that the gripper, as soon as it is engaged with the conveyor belts, is conveyed thereby and not by the drive 20, 21 in the direction of the blade. Accordingly, the gripper serves merely to hold and not to drive the food product block.

FIG. 2b shows the slicing machine according to FIG. 2a in plan view, wherein the conveyor belts 4 have been omitted for the sake of clarity. The present example of a slicing machine is suitable for slicing four food product blocks arranged in parallel in a plane. Accordingly, the slicing machine has four grippers 18, which are each brought into contact with a food product block and whose claws 7 are driven into the food product block (not shown). The grippers 18 are arranged on a central unit 20, which may be displaced along a guide 22. Displacement of the central unit 20 may be effected either by a motor or by the food product blocks, which have been connected with the grippers and which are conveyed by mean of the conveyor belts 4 in the direction of the blade, or by the conveyor belts. The unit 20 may also be fixed in position relative to the guide 22. Each gripper 18 further comprises a drive 21, with which the gripper may be moved or fixed relative to the central unit 20. This drive 21 can be reset such that it functions as or similarly to a movable bearing, i.e. such that the gripper 18 may be displaced axially relative to the central unit 20. An example of means which may function simultaneously as a drive and similarly to a movable bearing is a cylinder, which, when acted upon by compressed air, constitutes a drive and in the absence of pressure effects decoupling with regard to force between the central unit 20 and the gripper 18. Additionally, the stroke limits of the cylinder in the form of its end positions constitute a limit stop, so ensuring that the gripper cannot be moved too far in the conveying direction of the food product block and thus come into contact with the blade. The mode of operation of the slicing device according to the invention is explained in FIGS. 3a to 3c and 4a to 4c.

FIGS. 3a to 3c show one mode of operation of the device according to the invention. FIG. 3a shows the situation before slicing of the food product blocks 2. The food product blocks 2 are inserted in each case manually or mechanically into a guide passage and brought into contact with a limit stop 16, in the present case a slide, such that the ends facing the blade 11 (not shown) are located in a plane parallel to the blade. The person skilled in the art will recognize that a limit stop is not necessarily required for this purpose. Moreover, the person skilled in the art will recognize that the food product blocks are of different lengths, which corresponds to practical experience. The food product blocks 2 are conveyed in the direction of the blade by conveyor belts 4. The conveyor belts may be individually driven, such that each individual food product block is advanced in adjustable manner and thus the respective thickness of the severed slices is adjustable; i.e. the rate at which the food product blocks are each sliced may differ. The grippers 18 are located in the present case behind the rear end of the food product blocks 2. Before or during slicing, the central unit 20, on which the grippers are arranged, is moved by a motor along the guide 22 in the direction of the rear ends of the food product blocks, until a gripper 18 comes into contact with a food product block. The claws of this gripper are then brought into engagement with this food product block. The grippers 18 are mounted or driven in such a way relative to the central unit 20 that they are brought into contact with the respective food product blocks in succession or simultaneously and may be connected therewith without the food product blocks suffering appreciable compression. This procedure has the advantage, in particular before the slicing starts, that the food product blocks are not pressed appreciably against the limit stop 16, such that the limit stop may be removed without the food product blocks being damaged. Also, the grippers do not have to draw the food product blocks back, as taught for example in DE 100 50 713 A1, in order to be able to remove the limit stop at all. A further advantage of the present invention is that the parallel alignment of the front ends of the food product blocks is maintained even after they have been connected to the grippers. This embodiment of the present invention has the advantage that a so-called trimming cut, which signifies a loss of material, does not necessarily have to be carried out prior to slicing of the food product blocks in order to achieve parallel alignment of the food product blocks in a line. During slicing, this procedure according to the invention has the advantage that, on production of the contact between gripper and food product block, no food product slices of uncontrolled thickness arise. After all the grippers have been brought into contact with the respective food product blocks, both the drive of the central unit and the drives 21 of the respective grippers 18 may be stopped, such that the central unit 20 is mounted so as to be freely displaceable along the guide 22 and the grippers 18 are mounted so as to be freely displaceable in the guides 21, such that the grippers 18 and thus the central unit 20 are drawn towards the blade by the food product blocks 2. Furthermore, it is possible for the central unit 20 to be moved by a motor at a moderate speed along the guide 22. In this case, the grippers 18 are mounted displaceably and may be provided with a sensor, which transmits their respective positions to a control unit, such that the control unit receives information for example as to whether one food product block is being sliced more quickly than the others. It is additionally possible for the central unit 20 to be mounted so as to be freely displaceable along the guide 22 and for the grippers not to be movable relative to the central unit, thereby ensuring that, at least after contact with the grippers 18, all the food product blocks are sliced at the same rate. In any case, the grippers are not driven by their own drives after contact with the food product block and are therefore also not in a position to drive the food product blocks towards the blade. The grippers 18 are either moved towards the blade by the food product block and/or preferably by the conveyor belts 4. FIG. 3c shows a stage shortly before completion of slicing. Since the food product blocks on the one hand are of unequal length and on the other hand may also be sliced at different rates, the second food product block from the left has been sliced as far as just in front of the gripper claws. At this point, slicing of this food product block at least must be terminated, in that this food product block is withdrawn for example by its drive 21. It is also feasible, however, for slicing of all four food product blocks to be terminated at this point, by moving the central unit 20 away from the blade and thereafter or simultaneously detaching the claws from the food product blocks. The incompletely sliced food product blocks may be collected and sent for re-use. Once slicing of the food product blocks has been terminated, the central unit 20 is moved back to the starting position according to FIG. 3a and the claws 18 are likewise moved back relative to the central unit 20 and the guide passages may be charged with new food product blocks, these then being sliced.

FIGS. 4a to 4c show another possible embodiment of the device according to the invention or the method according to the invention. As is clear from FIG. 4a, in the present case the food product blocks are of such a length that their rear end lies behind the grippers and the food product block lies at least partially under the gripper. The food product blocks are also in the present case arranged and fixed by the conveyor belts in such a way that their front ends are located in a plane parallel with the blade, such that no trimming cut has to be performed at the start of slicing. The food product blocks are sliced until their rear ends are located in front of the grippers 18, which are then brought into engagement with the food product blocks at any desired point, but at the latest when it can no longer be guaranteed that the food product blocks will be held securely between the conveyor belts 4. Otherwise, the explanations made with regard to FIGS. 3a to 3c apply.

FIG. 5 shows a food product block 2 and a product extender 1, wherein in the upper part of the Figure the two components are shown separated from one another and in the lower part of FIG. 5 a force-locking connection is shown between the food product block and the product extender. The food product block 2 is in the present case a cylinder, such that the cross-sectional face 9, i.e. the food product block viewed from the front, is a circle. The product extender 1 comprises a cylindrical outer circumferential surface 3, which is able to cooperate with the conveyor belts 4 of the slicing machine 5 to convey the product extender 1 in the feed passage to the cutting plane 6. The cross-section 8 of the extending device 1 is likewise a circle in the present case. At its end face 10 the product extender 1 comprises claws, with which a force-locking, reversible connection may be produced between the product extender I and the food product block 2. On the opposing end face the product extender 1 comprises a means 15 with which the product extender is moved inside a slicing machine before and after slicing of the product block.

In the lower part of FIG. 5, connection of the product extender to the food product block is shown. It is clear that the claw or grip system 7 of the product extender 1 is brought into engagement with the food product block only once a certain number of food product slices has been severed therefrom. However, the person skilled in the art will recognize that engagement of the product extender may proceed prior to slicing or has to proceed only when the food product block has become so short that controlled severing of food product slices from the product block can no longer reliably be ensured. The product extender according to the invention has the advantage that the food product block may be sliced until the blade comes into contact with the claws 7. The manner in which the claws engage, the depth of engagement and the force with which they engage in the food product block are dependent on the product.

FIG. 6 shows a virtually continuous slicing device with a food product block and a product extender in the feed channel. In the present case, the product extender 1 is already engaged with the food product block 2. The two components are conveyed together by the conveyor belts 4 in the direction of the cutting blade 11, such that the product extender is not driven during slicing. Once the food product block has been sliced, the product extender is removed from the feed passage with the end of the food product block still attached thereto, the end of the food product block is disconnected from the product extender and the product extender 1 is brought by the drive means 13 into engagement with the food product block then to be sliced.

### LIST OF REFERENCE NUMERALS

1 Food product block extender
2 Food product block
3 Outer circumferential surface
4 Conveying means
5 Slicing device
6 Cutting plane
7 Means for producing a force-locking, interlocking and/or materially bonded connection
8 Cross-section of the food product block-extending means
9 Cross-section of the food product block
10 End face of the food product block-extending means
11 Blade
12 Food product slices
13 Means for bringing the food product block extender up to the food product blocks
14 Feed passage
15 Means
16 Limit stop
17 End of a food product block remote from the blade
18 Gripper
19 End of a food product block facing the blade
20 Central unit
21 Gripper drive
22 Central unit guide

1-23. (canceled)

24. A method for simultaneously slicing at least two food product blocks (2) fed in parallel to a blade (11), in which the food product blocks (2) are each inserted into a feed passage (14)
optionally brought into contact with a limit stop (16),
conveyed towards the blade (11) and sliced, and
the ends (17) of the food product blocks (2) remote from the blade are each brought into contact with a means (1, 18),
characterized in that contact between the means (1, 18) and the food product block (2) occurs only during slicing of the respective food product block (2).

25. A method for simultaneously slicing at least two food product blocks (2) fed in parallel to a blade (11), in which
the food product blocks (2) are each inserted into a feed passage (14)
optionally brought into contact with a limit stop (16),
conveyed towards the blade (11) and sliced,
the ends (17) of the food product blocks (2) remote from the blade are
each brought into contact with a means (1, 18) and
the means (1, 18) is driven by at least one conveying means (4), which
also conveys the food product blocks (2),
characterized in that there is only a frictional connection between the means (1, 18) and the conveying means (4), such that the food product blocks (2) are not compressed or are compressed only insignificantly by the means (1, 18).

26. A method for slicing a food product block (2) fed to a blade (11, characterized in that the food product block (2) is conveyed towards the blade (11) by at least one conveying means (4) and in that, at any desired time during slicing of the food product block, the rear end (17) of the food product block (2) is brought into contact in each case with a means (1, 18) and in that the means is driven during said contact with the food product block by the food product block (2) and/or the conveying means (4).

27. A method according to claim 24, characterized in that the front ends (19) of the food product blocks are arranged in such a way that, before the first cut, they are located in a line in a plane substantially parallel to the cutting plane (6) of the blade (11), such that no trimming cut has to be performed.

28. A method of slicing food product blocks, characterized in that a food product block is brought into contact with a means (1) for extending food product blocks (2) during slicing and is extended artificially by the means (1).

29. A method according to claim 24, characterized in that the means (1, 18) is connected to the food product block reversibly and force-lockingly, interlockingly and/or by material bonding.

30. A method according to claim 25, characterized in that connection of the means (1, 18) takes place before or preferably after slicing starts.

31. A method according to claim 24, characterized in that the means (1, 18) is removed from the feed passage after slicing.

32. A method according to claim 24, characterized in that the connection between the means (1, 18) and the food product block (2) is broken once slicing of at least one food product block is completed.

33. A method according to claim 24, characterized in that the means (1) is driven, at least at times, solely by the conveying means (4) of the food product block and/or by the food product block (2).

34. A method according to claim 24, characterized in that, at least towards the end of the respective slicing process, the means (1, 18) is/are in each case engaged with at least one conveying means (4).

35. A method according to claim 24, characterized in that a plurality of food product blocks are sliced in parallel.

36. A device for severing food product slices (12) from at least two food product blocks (2) with a blade (11), in which device the food product blocks (2) may be conveyed towards the blade (11) in each case by at least one conveying means (4) and their rear ends (14) are in contact at least for a time with a means (1, 18), wherein the means (18) is not driven by its own drive during contact with the food product block (2) characterized in that the means are arranged on a central unit (20), which is arranged on the device so as to be displaceable at least at times in parallel with the axis of rotation of the blade (11).

37. A device for severing food product slices (12) from at least two food product blocks (2) with a blade (11), in which device the food product blocks (2) may be conveyed towards the blade (11) in each case by at least one conveying means (4) and their rear ends (14) are in contact at least for a time with a means (1, 18), wherein the means (18) is not driven by its own drive during contact with the food product block (2) characterized in that the means are mounted on a central unit (20) so as in each case to be displaceable at least at times.

38. A device according to claim 36, characterized in that the means (1, 18) comprise a sensor with which their positions relative to the central unit may be determined.

39. A means (1) for extending food product blocks (2) in the axial direction, having an outer circumferential surface (3) which cooperates force-lockingly and/or interlockingly with conveying means (4), which convey the food product blocks (2) within a slicing device (5) towards the cutting plane (6), and a means (7) arranged at the end face which effects a force-locking, interlocking and/or materially bonded connection between the means (1) and the food product block (2), characterized in that the cross-section (8) of the outer circumferential surface (3) may vary in shape and/or size.

40. A means according claim 39, characterized in that it may be driven by the conveying means (4) at least in the conveying direction of the food product block after force-locking, interlocking and/or materially bonded connection with the food product block (2).

41. A means according to claim 39, characterized in that the means (7) is a claw and grip system.

42. A means according to claim 39, characterized in that the means (7) comprises a vacuum between the food product block and the end face (10).

43. A slicing device with a blade (11) which severs food product slices (12) from a food product block (2), which may be conveyed by conveying means in a feed passage in the direction of the blade, characterized in that it comprises a means which conveys a product extender (1) according to claim 39 to the food product block to be sliced and/or removes it from the product passage.

44. A slicing device according to claim 43, characterized in that it comprises a means (13) which picks up the food product extender (1) after removal thereof and brings it up to the end of a further product block.

45. A slicing device according to claim 43, characterized in that it comprises a means with which a force-locking, interlocking and/or materially bonded connection is produced between the food product block and the product extender.

46. A slicing device according to claim 43, characterized in that it is driven by the conveying means at least in the conveying direction of the food product block and after the force-locking, interlocking and/or materially bonded connection.
